(19) United States
(12) Patent Application Publication
(10) Pub. No.: US 2009/0137133 A1
(43) Pub. Date: May 28, 2009

(54) F-type right angle jack

(76) Inventor: Pony Gou, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 11/984,914

(22) Filed: Nov. 26, 2007

(51) Int. Cl. H01R 12/00

(52) U.S. Cl. 439/63

(57) ABSTRACT

F-type right angle jack of tap assembly manufactured in a few steps lowering signal loss ratio comprises a bayonet mount, a male connector axially disposed inside the bayonet mount, a right angle connector is in-line coupled to the male connector, a cubic coupling box, corner legs of a metallic frame inserted onto printed circuit board (PCB). The coupling box is directly formed between the bayonet mount and the male connector by injection molding. The coupling box wraps around a tapered tube of the bayonet mount filled with insulation material. A joint of the right angle connector and the male connector is wrapped around by the coupling box, but a proximal end of the right angle connector is exposed outside the coupling box. And a metallic frame squarish in shape formed by stamping and bending is wrapped around the coupling box to facilitate coaxial cable carries signals without loss.

### FIELD OF THE INVENTION

The present invention is related to an F-type right angle jack of tap assembly for transmission television (TV) or cable antenna television (CATV) signals applicable to analog television system such as National Television System Committee (NTSC), international electronic commission (IEC), phase alternating line (PAL), Séquentiel couleur á mémoire (SECAM), and manufacturing method of the same.

### DESCRIPTION OF PRIOR ARTS

As shown in FIGS. 1 and 2, a conventional tap assembly comprising an F-type right angle jack (or BNC-bayonet Neill-Concelman connector—right angle jack) fixed to a printed circuit board (PCB)—such a connector placed on coaxial cables that would minimize wave reflection/loss—for transmitting TV or CATV signals, it includes a bayonet mount (6) riveted to a lateral side of a squarish housing (8), wherein the bayonet mount (6) has a housing made of metal surrounding a male connector (60) can be used as grounding. The male connector (60) is axially disposed inside the bayonet mount (6); a proximal end of the male connector (60) is coupled to an insulator (62) stably; in turn, the insulator (62) is further fixed inside the housing of the bayonet mount (6). Furthermore, the proximal end of the male connector (60) is connected to a right angle connector (7) hidden inside the squarish housing (8) made of metal. A plastic insulation spacer (9) is disposed to a bottom of the squarish housing (8). A proximal end of the right angle connector (7) is extended through the plastic insulation spacer (9) to an outside of the squarish housing (8). Four corner legs (81) of the squarish housing (8) surround the proximal end of the right angle connector (7), both of the corner legs and the proximal end of the right angle connector (7) are plugged and welded to the PCB (not shown).

Said conventional F-type right angle jack of tap assembly has some drawbacks as following:

1. The squarish housing (8) made of metal is shaped by molding cast, and the bayonet mount (6) is riveted to the housing by riveting. In manufacturing, it needs more steps to finish the F-type right angle jack.

2. Right angle connector (7) disposed inside a hollowed out metal housing (8). But the right angle connector (7) is connected to the squarish housing by only two “anchor” points between curved segments. It leads to poor contact. Quality of signal transmission is lowered.

3. The bayonet mount (6) is riveted to the housing (8) by riveting. The housing (8) needs interior hardness and surface evenness evenly formed to process with the bayonet mount. The housing (8) is preferably shaped in cast molding, not only valuable molds are expensive, but more raw materials be wasted in manufacturing.

### SUMMARY OF THE INVENTION

The present invention is to provide a tap assembly made through simplified steps, signal loss ratio of the finished tap assembly also can be reduced.

The F-type right angle jack of tap assembly manufactured by steps comprising:

Step 1: assembling major components of a bayonet mount (1);

Step 2: assembled bayonet mount (1) is coupled to a right angle connector (2);

Step 3: a coupling box (3) is directly formed between the bayonet mount (1) and the right angle connector (2) by injection molding; and

Step 4: a metallic frame (4) is wrapped around the coupling box (3) to facilitate coaxial cable carries signals without loss.

The F-type right angle jack of tap assembly manufactured by steps as above wherein the metallic frame (4) is shaped by first stamping a metal plate, and then bending the metal plate in shape.

The F-type right angle jack of tap assembly manufactured by steps as above wherein two hangers (43) are stamped inward to withstand a bottom of the coupling box (3).

The F-type right angle jack of tap assembly manufactured by steps as above wherein, a male connector (10) of the bayonet mount (1) is coupled to the right angle connector (2) selectively by one of the following means: in-line coupling, welding, riveting, screwing, or formed integrally as a whole one.

The F-type right angle jack of tap assembly manufactured by steps as above wherein said coupling box (3) can be shaped by one of the following means: injection molding, cast molding.

An F-type right angle jack of tap assembly comprising: a male connector (10) axially disposed inside a bayonet mount (1) having a housing surrounding the male connector (10) as grounding, a right angle connector (2) is coupled to a proximal end of the male connector (10), a coupling box (3) wrapped around the right angle connector having an insulation capacity, a metallic frame (4) has corner legs (41) is joined to the housing of the bayonet mount (1); the corner legs (41) of the metallic frame (4) and the proximal end of the right angle connector (2) plugged to a printed circuit board (PCB); characterized in that: a proximal end of the bayonet mount (1) formed as a tapered tube and the right angle connector (2) are wrapped around by the coupling box (3), but a proximal end of the right angle connector (2) is exposed out of the coupling box (3); the metallic frame (4) wraps around the coupling box (3) to facilitate coaxial cable carries signals without loss.

The F-type right angle jack of tap assembly as above wherein a side wall of the metallic frame (4) has pawls (42) inclined inward by stamping for tightly crimping the coupling box (3).

The F-type right angle jack of tap assembly as above wherein hangers (43) at a bottom inner rim of the metallic frame bent inward for propping up a bottom of the coupling box (3).

The F-type right angle jack of tap assembly as above wherein the bayonet mount (1) has a housing surrounding the male connector, the housing joined to the metallic frame integrally used as grounding is applicable to analog TV systems such as National Television System Committee (NTSC), phase alternating line (PAL), Séquentiel couleur á mémoire (SECAM).

### ADVANTAGES OF EMBODIMENTS OF THE INVENTION

Advantages can be achieved by embodying the present invention as following:

1. The coupling box (3) directly formed between the bayonet mount (1) and the metallic frame (4) by injection molding instead of conventional riveting. Thus, the process of manufacturing the F-type right angle jack can be simplified to a few steps lowering manufacturing cost.

2. The right angle connector (2) is in-line coupled to the proximal end of the bayonet mount (1) further the joint is fixed in position and wrapped around by the coupling box (3). Thereby the right angle connector (2) is disposed inside the coupling box (3) stably without any movements. Problems of poor contact are eliminated. Quality of transmission is improved.

3. The coupling box (3) is introduced between the male connector (2) and the metallic frame (4) to fill up a clearance in between instead. Since the metallic frame (3) is made of metal, and the coupling box (3) with insulation capacity is sealed below the metallic frame (4) to electrically or thermally insulate noise from interference with the male connector, signal transmission loss can be reduced by the metallic frame.

4. The metallic frame (4) wrapped around a surface of the coupling box (3) is joined to a cylindrical housing of the bayonet mount (1). The housing surrounding the male connector is coordinated with the metallic frame together to form grounding. Slim metal plate processed through stamping and bending is shaped as the metallic frame, which is not finished through conventional cast molding. Metal material for manufacturing metal frame can be saved.

### BRIEF DESCRIPTION OF THE DRAWINGS

FIG. 1: shows a schematic view of conventional F-type right angle jack of analog PAL system.

FIG. 2: shows a sectional view of FIG. 1.

FIG. 3: shows a schematic view of a female F-type right angle jack of the first embodiment of the present invention.

FIG. 4: shows a schematic view of a female F-type right angle jack of the second embodiment of the present invention.

FIG. 5: shows a schematic view of a male F-type right angle jack of the third embodiment of the present invention.

FIG. 6: shows a sectional view of FIG. 5.

FIG. 7: shows an exploded view of FIG. 5.

FIG. 8: shows a diagrammatic view of manufacturing process of the invention.

FIG. 9: shows a schematic view of manufacturing process of the invention.

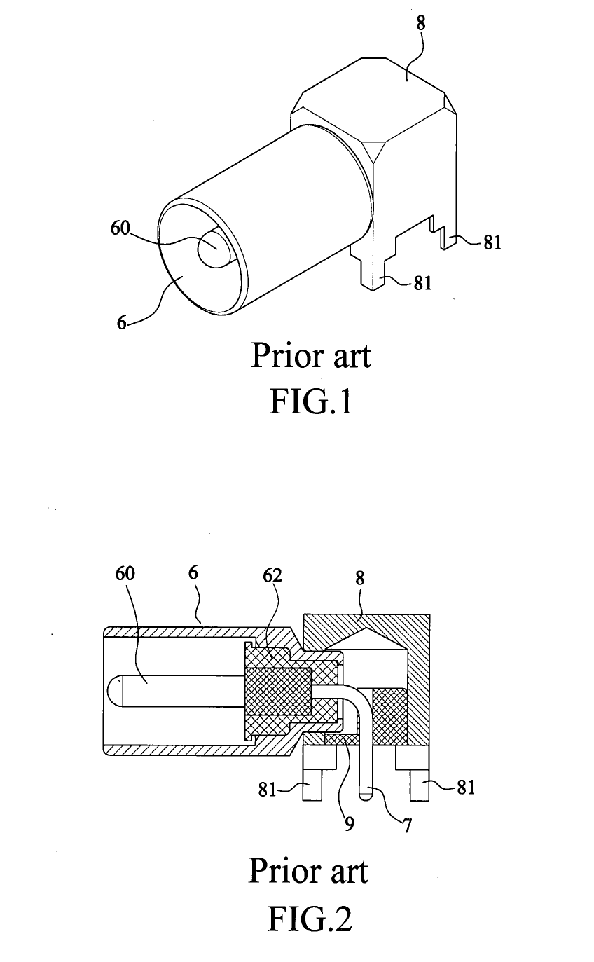

### DETAILED DESCRIPTION OF THE PREFERRED EMBODIMENTS OF THE INVENTION

Detailed description of the invention is described according to the appended drawings hereinafter.

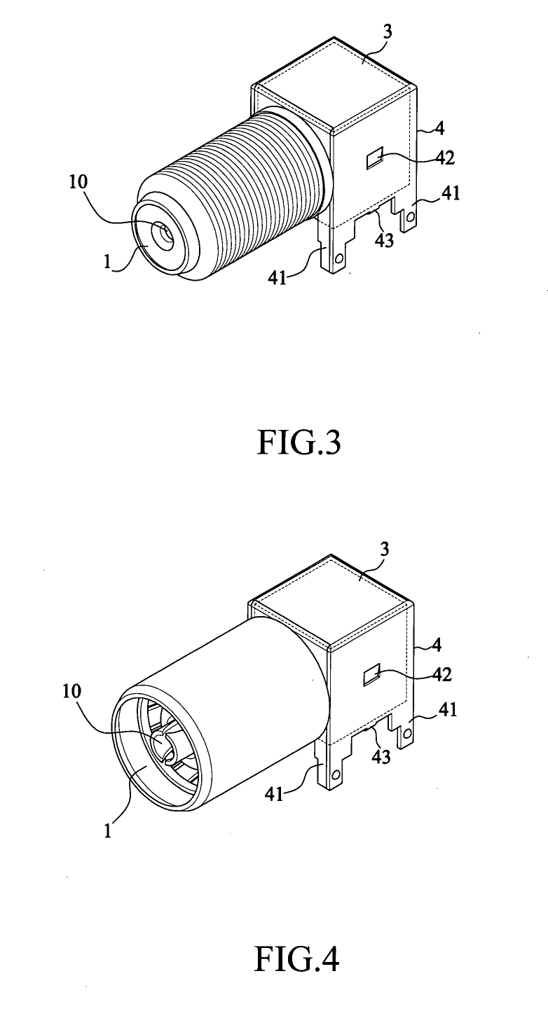

As shown in FIG. 3, a female F-type right angle jack of national television systems committee (NTSC) is illustrated; in FIGS. 4 & 5, a female F-type right angle jack and a male F-type right angle jack of phase alternate lines (PAL) are illustrated, and a F-type right angle jack of sequential color and memory (SECAM, not shown), which is not familiar to us, looked alike on the market. Said female or male F-type right angle jacks of tap assembly are mainly different from one another bayonet mounts adjacent to the housing but connected by riveting, which make no difference in the prior art. However, bayonet mount adjoins the housing by wrapping around metallic frame is featured in the present invention to be different from the prior arts.

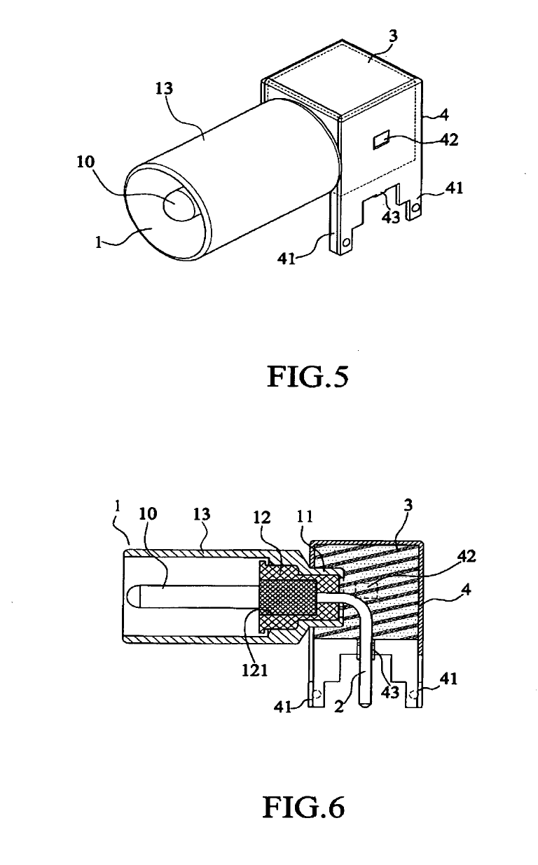

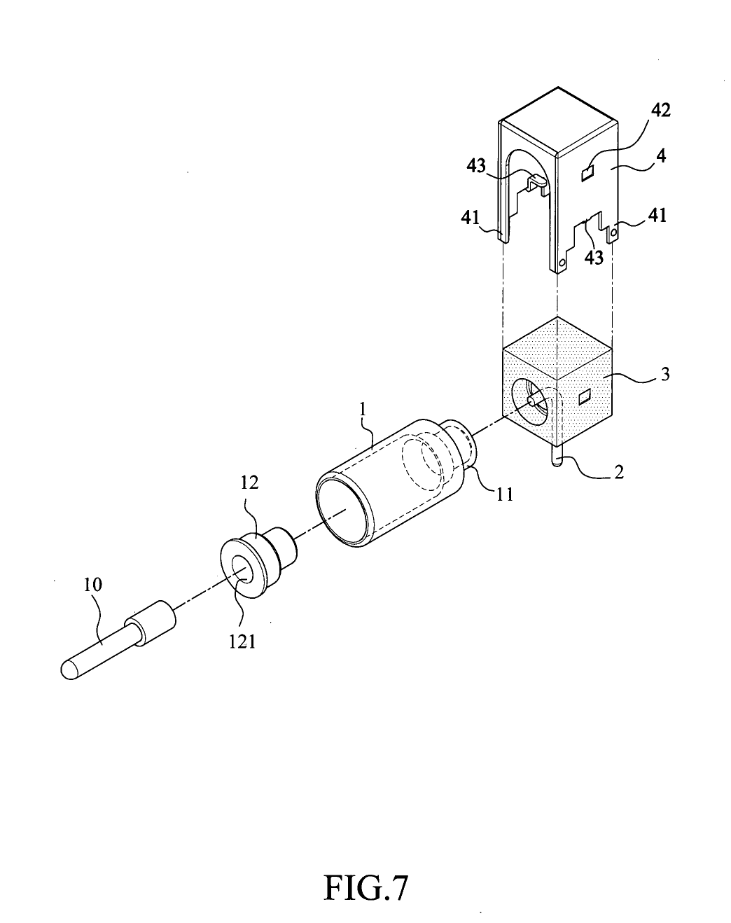

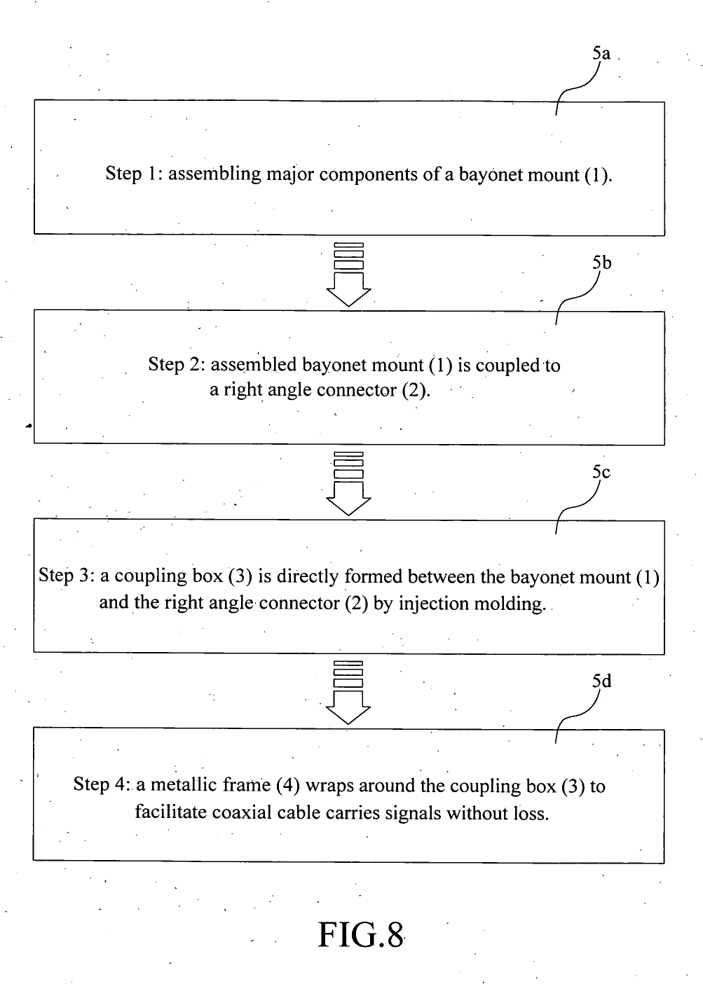

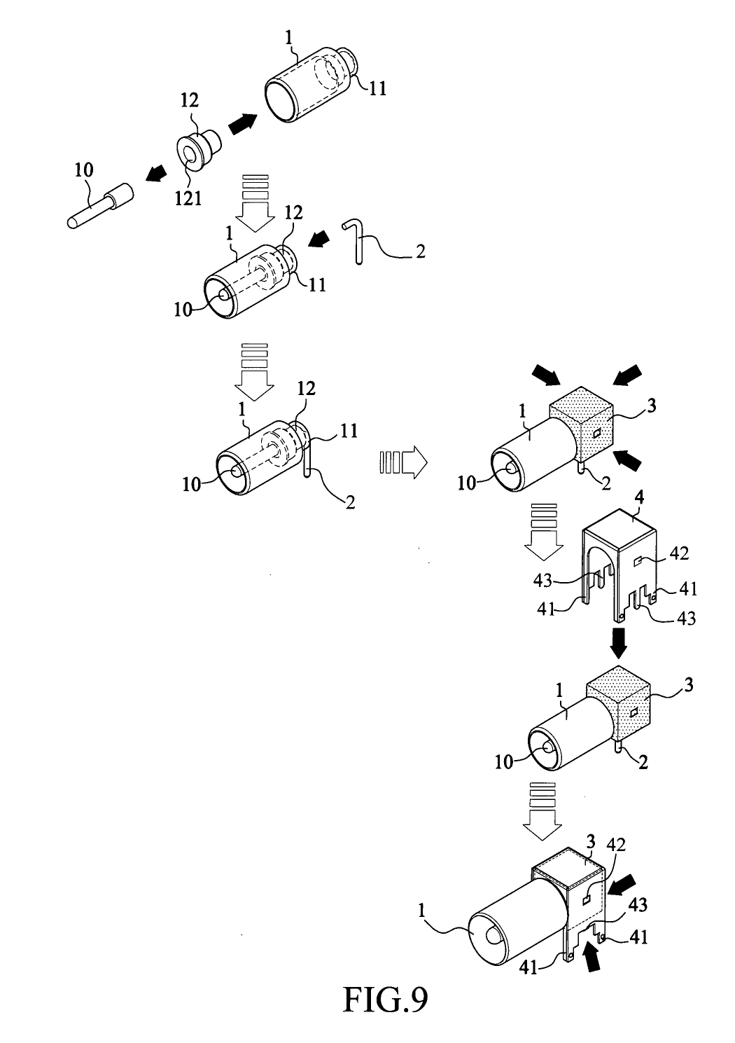

As shown in FIG. 5, the male F-type right angle jack of PAL analog television (TV) system is illustrated, also refer to FIGS. 6, and 7, an F-type right angle jack comprising: a male connector (10) axially disposed inside a bayonet mount (1) having a housing surrounding the male connector (10) as grounding, a right angle connector (2) is coupled to a proximal end of the male connector (10), according to FIG. 7, the male connector (10) is substantially shaped as male-to-female connector, but the right angle connector (2) is shaped as male-to-male connector. The proximal end of the male connector (10) shaped as a female connector is therefore in line coupled to the distal end of the right angle connector (2) shaped as male connector. A coupling box (3) is wrapped around the right angle connector (2) with an insulation capacity due to the coupling box (3) is made of plastic by injection molding. A metallic frame (4) has corner legs (41) is joined to a cylindrical housing of the bayonet mount (1) by a first lateral side. A proximal end of the bayonet mount (1) is formed as a tapered tube, which extends into the metallic frame (4) is also wrapped around by the coupling box (3). But a proximal end of the right angle connector (2) is extended out a second lateral side of the coupling box (3); the second lateral side of the coupling box (3) is at a right angle as an included angle between them. While the metallic frame (4) wraps around the coupling box (3) preventing the signal transmission from noise interference to TV set reception. Corner legs (41) of the metallic frame (4) and the proximal end of the right angle connector (2) are oriented in the same direction and projected out of the second lateral side of the coupling box (3), being together plugged to a printed circuit board (PCB).

The right angle connector (2) and a proximal end of the male connector (10) are coupled together by in-line coupling, which is further wrapped around by the coupling box (3) stably. The coupling box (3) introduced between the right angle connector (2) and the metallic frame (4) with electrically and thermally insulation capacity is turned into an insulator in between. By means of the metallic frame (4), signal loss or interference can be lowered to a minimum. Signals transmission to TV set reception is therefore quite stable.

The coupling box (3) is shaped as a body centered cubic box, the metallic frame (4) is a thin metal plate processed through first stamping and then bending to wrap around the surface of coupling box (3). Furthermore, a third lateral side of the metallic frame (4) opposite to the first lateral side is centrally stamped to form a pawl (42) at a center, where the pawl is inclined inward to crimp the coupling box (3) tightly like a cartridge. Furthermore, a bottom rim of the metal frame (4) is equipped with hangers (43), which are bent inward to prop up a bottom of the coupling box (3). The coupling box (3) is therefore prevented from downward sliding out of the metallic frame (4).

As shown in FIG. 6, the tapered tube (11) at the proximal end of the bayonet mount (1) having a diameter smaller than the bayonet mount (1), the tapered tube (11) is wrapped around by the coupling box (3). The tapered tube (11) is securely filled with an insulation material (12). While the proximal end of the male connector (10) (a female connector) is inserted through the insulation material (12) in line coupled to the distal end of the right angle connector (2). It exemplifies that the coupling box (3) is not only secured to the tapered tube (11) of the bayonet mount (1), but also adapted to the metallic frame (4) without any movements in a few steps in manufacturing. Producer can therefore save labor cost and material cost.

As above, the present invention is exemplified by producing a male F-type right angle jack. A female F-type right angle jack of the present invention can be produced by the same steps.

As above, a variety of female and male F-type right angle jacks included in the tap assembly; when manufacturing, the bayonet mount is first required to be assembled, and then the manufacturing process can be sped up realized by a few steps more simplified than the conventional riveting method.

Besides, the right angle connector (2) can be fixed by the coupling box (3), whereby the right angle connector (2) is not easy to slide out of the coupling box (3) and the metallic frame (4). Poor contact can be eliminated. And the F-type right angle jack is easy electrically connected to other devices.

A joint between the tapered tube (11) and the right angle connector (2) is wrapped around by the coupling box (3). The metallic frame (4) later, in turn, wrapped around the coupling box (3) is electrically insulated from the right angle connector (2) by the coupling box (3). The metallic frame (4) is therefore applied to prevent noise from interference with signals transmission to TV set reception. Signal loss or interference can be lowered to a minimum.

In addition, the metallic frame (4) wrapped around the joint between the bayonet mount (1) and the right angle connector (2) and an outer surface of the coupling box (3) is produced by stamping and bending a thin metal film, which is more inexpensive than raw material wasted in cast molding.

The male connector (10) of the bayonet mount (1) is coupled to the right angle connector (2) selectively by one of the following means: in-line coupling, welding, riveting, screwing, or formed integrally as a whole one. In consideration of different requirements of the tap assembly, different bayonet mounts can be coupled to the right angle connector (2) by different methods.

The coupling box (3) can be shaped by one of the following means: injection molding, cast molding. Since the coupling box (3) is preferably made of plastic; therefore, the coupling box (3) is preferably shaped by injection molding.

As shown in FIG. 11, the F-type right angle jack of tap assembly can be assembled in few steps, exemplified by the F-type right angle jack illustrated in FIG. 7.

Step 1 (5a), major components of the bayonet mount, includes the tapered tube (11) at the proximal end of the bayonet mount, where filled with the insulation material (12), and the male connector (10) inserted inside the bayonet mount through the insulation material (12) are assembled together as a whole.

Step 2 (5b), after assembling, the assembled bayonet mount (1) is coupled to the right angle connector (2) due to the male-to-female male connector (10) is in-line coupled to the male-to-male right angle connector (10) as a joint at the proximal end of the male connector and the distal end of the right angle connector.

Step 3 (5c), the cubic coupling box (3) is directly formed between the bayonet mount (1) and the right angle connector (2) by injection molding, where the coupling box (3) is wrapped around the joint at the proximal end of the male connector and the distal end of the right angle connector.

Step 4 (5d), the metallic frame (4) is wrapped around the coupling box (3), the metallic frame (4) squarish in shape is shaped by stamping and bending.

1. The F-type right angle jack of tap assembly manufactured by steps comprising:
step 1: assembling major components of a bayonet mount (1);
step 2: assembled bayonet mount (1) is coupled to a right angle connector (2);
step 3: a coupling box (3) is directly formed between the bayonet mount (1) and the right angle connector (2) by injection molding; and
step 4: a metallic frame (4) is wrapped around the coupling box (3) to facilitate coaxial cable carries signals without loss.

2. The F-type right angle jack of tap assembly manufactured by steps of claim 1 wherein the metallic frame (4) is shaped by first stamping a metal plate, and then bending the metal plate in shape.

3. The F-type right angle jack of tap assembly manufactured by steps of claim 2 wherein two hangers (43) are stamped inward to withstand a bottom of the coupling box (3).

4. The F-type right angle jack of tap assembly manufactured by steps of claim 1 wherein a male connector (10) of the bayonet mount (1) is coupled to the right angle connector (2) selectively by one of the following means: in-line coupling, welding, riveting, screwing, or formed integrally as a whole one.

5. An F-type right angle jack of tap assembly comprising: a male connector (10) axially disposed inside a bayonet mount (1) having a housing (13) surrounding the male connector (10) as grounding, a right angle connector (2) is coupled to a proximal end of the male connector (10), a coupling box (3) wraps around the right angle connector having an insulation capacity, a metallic frame (4) has corner legs (41) is joined to the housing of the bayonet mount (1); the corner legs (41) of the metallic frame (4) and the proximal end of the right angle connector (2) plugged to a printed circuit board (PCB) (not shown); characterized in that: a proximal end of the bayonet mount (1) formed as a tapered tube and the right angle connector (2) are wrapped around by the coupling box (3), a proximal end of the right angle connector (2) is exposed out of the coupling box (3); the metallic frame (4) wraps around the coupling box (3) to facilitate coaxial cable carrying signals without loss;
the coupling box (3) is a cubic body centered box, the metallic frame (4) is a thin metal film processed through stamping and bending to form a metal film squarish in shape; a side wall of the metallic frame (4) has pawls (42) inclined inward by stamping for tightly crimping the coupling box (3); hangers (43) at a bottom inner rim of the metallic frame bent inward for propping up a bottom of the coupling box (3).

6-8. (canceled)

9. The F-type right angle jack of tap assembly of claim 6 wherein the bayonet mount (1) has a housing surrounding the male connector, the housing joined to the metallic frame integrally used as grounding is applicable to analog TV systems as National Television System Committee (NTSC).

10. The F-type right angle jack of tap assembly of claim 6 wherein the bayonet mount (1) has a housing surrounding the male connector, the housing joined to the metallic frame integrally used as grounding is applicable to analog TV systems as phase alternating line (PAL).

11. The F-type right angle jack of tap assembly of claim 6 wherein the bayonet mount (1) has a housing surrounding the male connector, the housing joined to the metallic frame integrally used as grounding is applicable to analog TV systems as Séquentiel couleur á mémoire (SECAM).
